(19) United States
(12) Patent Application Publication
(10) Pub. No.: US 2008/0287846 A1
(43) Pub. Date: Nov. 20, 2008

(54) Oral Cleaning Device with Internal Toothpaste

(76) Inventor: Kong Suk Song, Incheon (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/094,402

(22) PCT Filed: Sep. 19, 2006
(86) PCT No.: PCT/KR2006/003719

§ 371 Date: May 20, 2008

(30) Foreign Application Priority Data
Nov. 30, 2005 (KR) 20-2005-0033849

(51) Int. Cl. A61C 17/032

(52) U.S. Cl. 601/165

(57) ABSTRACT

The present invention relates to an oral cleaning device with comprises an opening/closing lever integrally mounted to an upper end portion of a hydrant for opening and closing the hydrant so as to discharge water supplied from the hydrant; and an oral cleaning unit detachably mounted to the hydrant for allowing toothpaste T contained in the oral cleaning device to be diluted with the water supplied from the hydrant in response to the opening/closing operation of the opening/closing lever, and then allowing the inside of a user's mouth to be cleansed by injecting the water diluted with the toothpaste T. Accordingly, a user can feel refreshment only by mouth gargling with the oral cleaning device without tooth brushing, thereby allowing the refreshment to be kept.

### TECHNICAL FIELD

The present invention relates to an oral cleaning device, and more particularly, to an oral cleaning device with internal toothpaste, in which a predetermined amount of toothpaste is stored in an oral cleaning unit so that the toothpaste is discharged to the oral cavity of a user with the washing water supplied into the oral cleaning unit when washing his or her oral cavity, thereby facilitating washing and sterilization of the oral cavity, and hence improving the oral cavity health.

### BACKGROUND ART

Generally, tooth decay and periodontitis among oral diseases from which many Korean people have been suffered can be prevented only by tooth brushing up to a certain degree. However, foreign substances causing tartar generated between respective teeth or between tooth and gingiva cannot be easily removed only by the tooth brushing. Thus, an interdental toothbrush or a dental floss is employed so as to remove such tartar.

Further, in order to remove foreign substances remained between respective teeth or between tooth and gingiva, electric oral cleaning devices have been recently used to wash the inside of a user's mouth by injecting high-pressure water. Such an oral cleaning device is operated such that it is plugged into an electrical outlet for supplying an electric power, and then when an operating button is pressed in a state where water is stored in a water tank of a main body, the water stored in the water tank is injected into the oral cavity of a user via an injecting hole through the operation of a pump, thereby washing the oral cavity.

However, the conventional electric oral cleaning devices as described above have problems in that water has to be re-stored in the main body whenever shortage of water occurs during using the water stored therein, in that the water pressure injected by a pump is decreased to result in reduction of the cleaning effect, in that a plug of the device has to be removed from the electrical outlet so as to be arranged after it is used, thereby causing inconvenience in use, in that a danger of electric shock due to the inevitable use of electricity is created, and in that an electromotor needs to be used, thereby increasing the manufacturing cost. Also, such a conventional electric oral cleaning device has a further problem in that a user cannot feel refreshment when mouth gargling with the water injected in response to the operation of the pump.

### DISCLOSURE

### Technical Problem

Accordingly, the present invention has been made in view of the above-mentioned problems occurring in the prior art, and it is an object of the present invention to provide an oral cleaning device with internal toothpaste, in which an oral cleaning unit is integrally mounted at a side of a hydrant, so that cold/hot water can be injected by the water pressure supplied from the hydrant without any danger of an electric shock, thereby providing convenience in use, and in which a predetermined amount of toothpaste is contained in the oral cleaning unit, so that a user can feel refreshment only by mouth gargling without tooth brushing, thereby allowing the refreshment to be kept.

### DESCRIPTION OF DRAWINGS

Further objects and advantages of the invention can be more fully understood from the following detailed description taken in conjunction with the accompanying drawings, in which:

FIG. 1 is a perspective view of an oral cleaning device with internal toothpaste according to the present invention;

FIG. 2 is a cross-sectional view of an oral cleaning device with internal toothpaste according to the present invention;

FIG. 3 is a perspective view showing a toothpaste storage section, to which the oral cleaning device is applied according to the present invention;

FIG. 4a is a cross-sectional view showing a state where toothpaste is contained in the toothpaste storage section of the oral cleaning device with internal toothpaste according to the present invention; and

FIG. 4b is a cross-sectional view showing a state where the toothpaste is diluted with water and injected according the present invention.

### BEST MODE

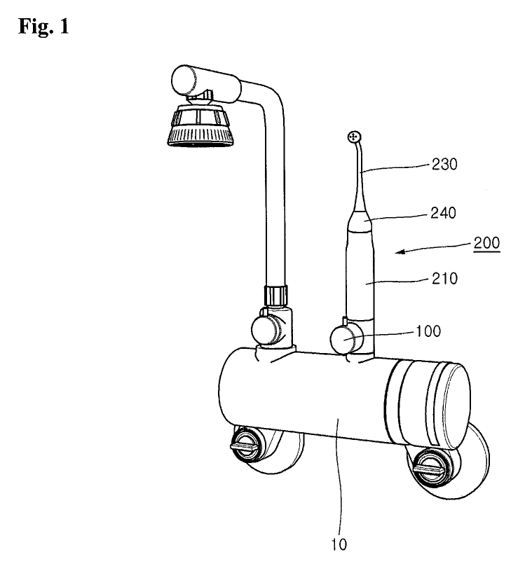

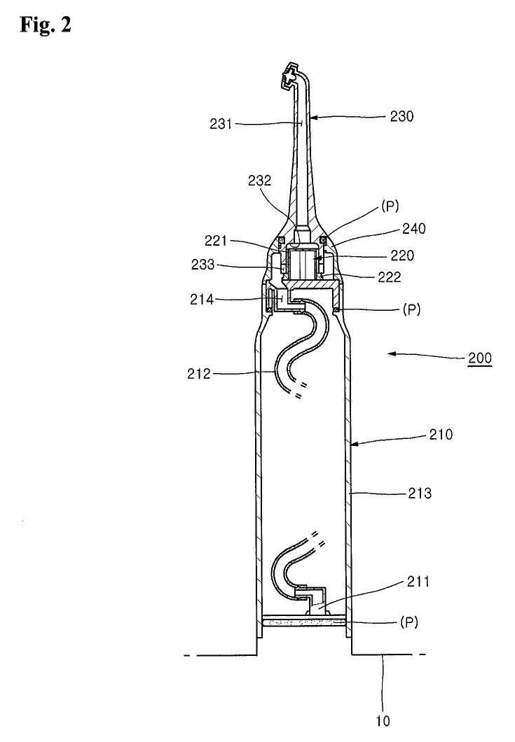

Hereinafter, a preferred embodiment of the invention will be explained in detail with reference to the appended drawings. FIG. 1 is a perspective view of an oral cleaning device according to the present invention, and FIG. 2 is a cross-sectional view of an oral cleaning device according to the present invention.

An oral cleaning device with internal toothpaste according to the invention comprises an opening/closing lever 100 integrally mounted to an upper end portion of a hydrant 10 for opening or closing the hydrant so as to discharge water supplied from the hydrant 10; and an oral cleaning unit 200 detachably mounted to the hydrant 10 for allowing toothpaste T contained in the oral cleaning device to be diluted with the water supplied thereto from the hydrant 10 in response to the opening/closing operation of the opening/closing lever 100 to produce a toothpaste solution, and then allowing the inside of a user's mouth to be cleansed by injecting the toothpaste solution.

In more detail, the oral cleaning unit 200 comprises a housing 210 formed on the lower portion thereof for guiding the water supplied from the hydrant 10 so as to be supplied to an injecting section 230; a toothpaste storage section 220 for storing toothpaste T therein so as to allow the toothpaste T to be diluted with the water supplied from the housing 210 to produce the toothpaste solution; the injecting section 230 formed on the upper portion of a support section 240 for injecting the toothpaste solution supplied from the toothpaste storage section 220 into the oral cavity of a user so as to clean the oral cavity of the user with the toothpaste solution; and a support section 240 mounted to the upper portion of the housing 210 so as to receive the lower end portion of the injecting section 210 and adapted to prevent the movement of the injecting section 230 and to guide the water supplied from the housing 210 so as to be supplied to the toothpaste storage section 220.

The housing 210 includes a water feed member 211 formed on a side of the hydrant 10 in such a manner as to be protruded upwardly and adapted to feed the water supplied from the hydrant 10; a guide member 212 fixed at one end thereof to the water feed member 211 for guiding the water supplied from the water feed member 211 and elastically extend from the water feed member 211 in such a manner as to be formed in a serpentine shape by a predetermined length; a grip member 213 seated on the upper portion of the water feed member 211 and adapted to receive the guide member 212 therein and protect the guide member; and a water guide element 214 coupled to the upper portion of the grip member 213 and fixed at an end thereof to the other end of the guide member 212 so as to guide the water supplied from the guide member 212.

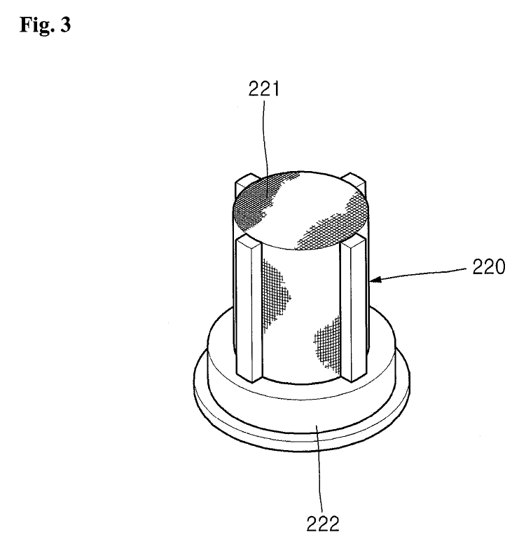

As shown in FIG. 3, the toothpaste storage section 220 includes a mesh-type storage portion 221 having a plurality of fine through-holes formed thereon and adapted to store the toothpaste T therein and allow the toothpaste solution to be supplied to the injecting section 230; and a support portion 222 formed on the lower portion thereof for receiving and supporting the mesh-type storage portion 221.

The injecting section 230 includes a receiving space 232 formed on the lower portion thereof to communicate with an injecting passageway 231 internally formed in the injecting section 230 and adapted to receive the toothpaste storage section 220 therein; and a plurality of guide holes 233 radially formed on the lower end portion of a side wall defining the receiving space 232 and adapted to guide the water supplied from the guide member 212 so as to be supplied to the toothpaste storage section 220 received in the receiving space 232.

The installment process of the oral cleaning device with internal toothpaste according to the invention configured as described above will be described hereinafter.

First, the guide member 212 is fixed at an end thereof to the water guide element 214. Next, the water guide element 214 is coupled to the grip member 213 in such a manner as to be seated on the upper portion of the grip member 213. Here, the guide member 212 is positioned inside the grip member 213 in such a manner as to be suspended from the top to the bottom of the grip member 213. After that, the guide member 212 is fixed at the other end thereof to the water feed member 211. At this time, the water guide element 214 and the grip member 213 are securely coupled to each other since a packing P mounted on the outermost lower end of the water guide element 214 pressurizes the inner peripheral surface of the grip member 213 and the outer peripheral surface of the water guide element 214.

The support section 240 is fastened and coupled to the upper portion of the grip member 213 so as to receive and support the water guide element 214 seated on the upper portion of the grip member 213. Here, the support section 240 may be coupled to the grip member 213 in such a manner as to be forcibly fitted thereto, or otherwise, to be welded thereto.

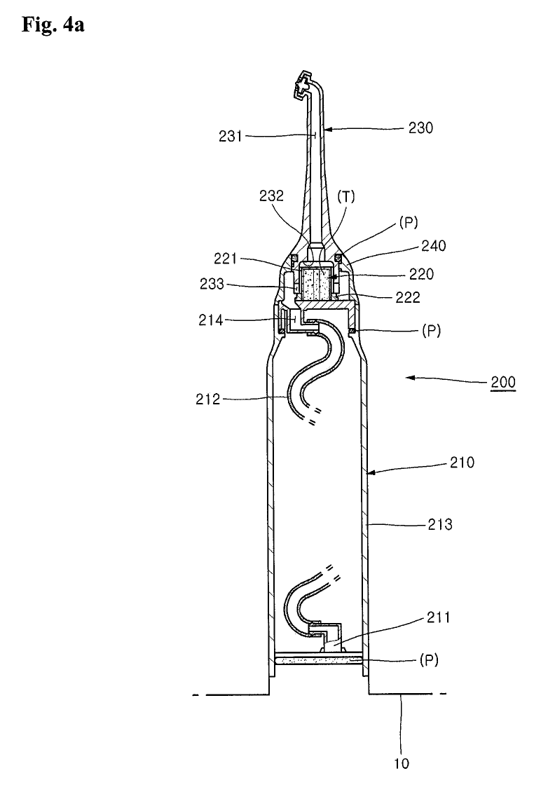

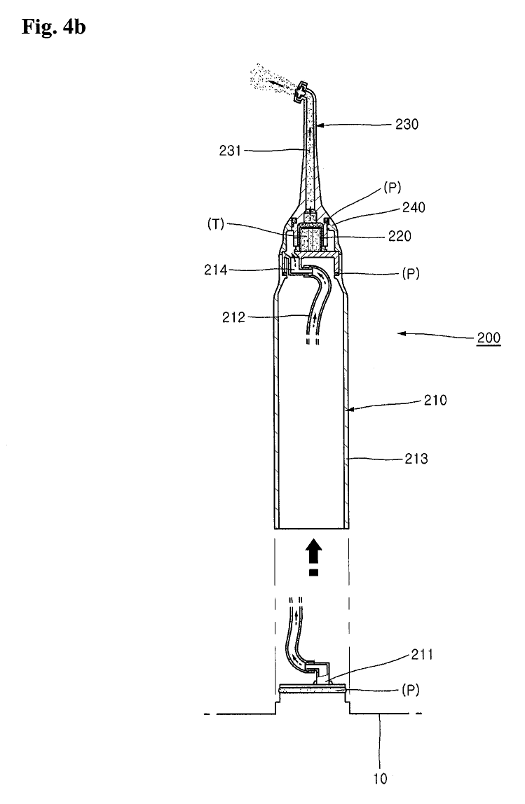

Further, as shown in FIG. 4a, the toothpaste T is put into the mesh-type storage portion 221 in a state where the mesh-type storage portion 221 is fixed at the inner peripheral surface of the support portion 222 of the toothpaste storage section 220. After that, the toothpaste storage section 220 with the toothpaste put therein is positioned in the receiving space 232 of the injecting section 230. When the lower portion of the injecting section 230 is coupled to the support section 240 in such a manner as to be positioned inside the support section 240, the injecting section 230 and the support section 240 securely pressurize the packing P coupled to the outer peripheral surface of the lower portion of the injecting section 230, and then the support section 240 coupled to the injecting section 230 is seated on the upper portion of the housing 210 so as to be coupled to the housing 210, thereby obtaining the secure coupling force between components of the oral cleaning unit 200.

The oral cleaning unit 200 coupled as described above may be operated after tooth brushing, or otherwise may be operated when cleaning the inside of a user's mouth by gargling.

Here, the operation of the oral cleaning unit 200 in case of cleaning the inside of a user's mouth by gargling will be explained in detail.

First, when a user grips the grip member 213 of the oral cleaning unit 200 and moves it upwardly from the hydrant 10, the housing of the oral cleaning unit 200 is removed from the water feed member 211, the guide member 212 is unfolded by the length by which the housing 210 is upwardly moved, and then the user places the injecting section 230 of the oral cleaning unit 200 so as to be positioned inside his or her mouth.

In such a state, the water, which is supplied from the hydrant 10 after the temperature of water is adjusted by rotating the opening/closing lever 100, is injected via the injecting section 230, thereby cleaning the inside of a user's mouth. When the water feed member 211 is opened from the close state of the hydrant 10 in response to the rotation of the opening/closing lever 100, the water, which is supplied from the hydrant 10 after the temperature of the water is adjusted, is supplied to the guide member 212 as shown in FIG. 4b, and supplied to the water guide element 214 passing through the guide member 212. Further, the water supplied to the water guide element 214 is supplied to the receiving space 232 via the guide holes 233 and then supplied to the mesh-type storage portion 221 having the plurality of fine through-holes formed thereon. After that, the toothpaste T contained in the mesh-type storage portion 221 is diluted with the water supplied to the mesh-type storage portion 221, to thereby produce the toothpaste solution while reacting the toothpaste T and the water to each other.

Further the toothpaste solution passes through the mesh-type storage portion 221 and injected to the outside via the injecting passageway 231 of the injecting section 230, to thereby clean the inside of a user's mouth with the toothpaste solution.

Here, foreign substances remained between the respective teeth can be removed therefrom and the gingiva can be massaged by means of the pressure of the toothpaste solution, which is injected via the injecting passageway 231 of the injecting section 230, while the user moves the oral cleaning unit 200.

When the opening/closing lever 100 is rotated in a reverse direction to the initial rotation direction after completing the use of the oral cleaning unit 200, the water feed member 211 communicating with the hydrant 10 is closed and the water supplying from the hydrant 10 is interrupted and the water diluted with toothpaste T is not injected via the injecting passageway 231 of the injecting section 230.

Further, when the grip member 213 of the housing 210 where a user grips with his or her hand is moved to the water feed member 211, the guide member 212 is elastically returned to its initial position so as to be positioned inside the grip member 213, and then the grip member 213 is mounted to the hydrant 10 so as to receive the water feed member 211 therein, thereby being placed in a standby state for the next operation of the oral cleaning unit 200.

Meanwhile, when the toothpaste T contained in the toothpaste storage section 220 is exhausted, the injecting section 230 is removed from the support section 240, toothpaste T is put into the mesh-type storage portion 221 of the toothpaste storage section 220, and then the oral cleaning device can be used by the process as described above in a state where the injecting section 230 is again mounted to the support section 240. Further, the injecting section 230 can be purchased according to the number of family members in consideration of the sanitation of a user in a state where the user cleans his or her mouth by using the injecting section 230. At this time, the injecting section 230 is attached or detached to/from the support section 240 in the same manner as the injecting section 230 is attached or detached to/from the support section 240 so as to allow the toothpaste T to be put into the mesh-type storage portion 221 of the toothpaste storage section 200, so that the injecting section 230 can be used for personal use of the user.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### ADVANTAGEOUS EFFECTS

As described above, according to the present invention, the oral cleaning device with internal toothpaste is integrally mounted at a side of the hydrant, so that cold/hot water can be injected by the water pressure supplied from the hydrant, thereby improving the cleaning effect. Also, since electricity is not used, there is not any danger of electric shock, as well as the economy in power consumption is increased due to the power saving.

Further, according to the present invention, toothpaste stored in the oral cleaning device is diluted with water and injected into the oral cavity so as to wash inside the mouth of a user when the oral cleaning device is used, so that a user can feel refreshment only by mouth gargling without tooth brushing, thereby allowing the refreshment to be kept.

What is claimed is:

1. An oral cleaning device with internal toothpaste comprising:
an opening/closing lever 100 integrally mounted to an upper end portion of a hydrant 10 for opening or closing the hydrant so as to discharge water supplied from the hydrant 10; and
an oral cleaning unit 200 detachably mounted to the hydrant 10 for allowing toothpaste T contained in the oral cleaning device to be diluted with the water supplied thereto from the hydrant 10 in response to the opening/closing operation of the opening/closing lever 100 to produce a toothpaste solution, and then allowing the inside of a user's mouth to be cleansed by injecting the toothpaste solution.

2. The oral cleaning device according to claim 1, wherein the oral cleaning unit 200 comprises;
a housing 210 formed on the lower portion thereof for guiding the water supplied from the hydrant 10 so as to be supplied to an injecting section 230;
a toothpaste storage section 220 for storing toothpaste T therein so as to allow the toothpaste T to be diluted with the water supplied from the housing 210 to produce the toothpaste solution;
the injecting section 230 formed on the upper portion of a support section 240 for injecting the toothpaste solution supplied from the toothpaste storage section 220 into the oral cavity of a user so as to clean the oral cavity of the user with the toothpaste solution; and
a support section 240 mounted to the upper portion of the housing 210 so as to receive the lower end portion of the injecting section 210 and adapted to prevent the movement of the injecting section 230 and to guide the water supplied from the housing 210 so as to be supplied to the toothpaste storage section 220.

3. The oral cleaning device according to claim 2, wherein the housing 210 includes: a water feed member 211 formed on a side of the hydrant 10 in such a manner as to be protruded upwardly and adapted to feed the water supplied from the hydrant 10; a guide member 212 fixed at one end thereof to the water feed member 211 for guiding the water supplied from the water feed member 211 and elastically extend from the water feed member 211 in such a manner as to be formed in a serpentine shape by a predetermined length; a grip member 213 seated on the upper portion of the water feed member 211 and adapted to receive the guide member 212 therein and protect the guide member; and a water guide element 214 coupled to the upper portion of the grip member 213 and fixed at an end thereof to the other end of the guide member 212 so as to guide the water supplied from the guide member 212.

4. The oral cleaning device according to claim 2, wherein the toothpaste storage section 220 includes: a mesh-type storage portion 221 having a plurality of fine through-holes formed thereon and adapted to store the toothpaste T therein and allow the toothpaste solution to be supplied to the injecting section 230; and a support portion 222 formed on the lower portion thereof for receiving and supporting the mesh-type storage portion 221.

5. The oral cleaning device according to claim 2, wherein the injecting section 230 includes: a receiving space 232 formed on the lower portion thereof to communicate with an injecting passageway 231 internally formed in the injecting section 230 and adapted to receive the toothpaste storage section 220 therein; and a plurality of guide holes 233 radially formed on the lower end portion of a side wall defining the receiving space 232 and adapted to guide the water supplied from the guide member 212 so as to be supplied to the toothpaste storage section 220 received in the receiving space 232.
